(19) United States
(12) Patent Application Publication
(10) Pub. No.: US 2024/0095721 A1
(43) Pub. Date: Mar. 21, 2024

(54) AUTOMATED INTERACTION WITH BLOCKCHAIN APPLICATIONS

(71) Applicant: Community Gaming, Inc., New York, NY (US)

(72) Inventors: Christopher Gonsalves, New York, NY (US); Hayder Sharhan, Houston, TX (US); Ivan Solomichev, Austin, TX (US); Abdullah Furkan Ozbek, Istanbul (TR); Sangat Das, Maharashtra (IN)

(21) Appl. No.: 18/318,520

(22) Filed: May 16, 2023

Related U.S. Application Data
(63) Continuation-in-part of application No. 17/949,559, filed on Sep. 21, 2022.

(51) Int. Cl. G06Q 20/36; G06Q 20/38

(52) U.S. Cl. CPC G06Q 20/3678; G06Q 20/389; G06Q 2220/00

(57) ABSTRACT

A facility for automating user interaction and cryptocurrency transactions with blockchain applications is described. The facility receives an indication of a user and generates a cryptocurrency wallet based on the indication of the user. The facility receives an indication of a Web3 application and identifies a smart contract associated with the Web3 application. The facility applies the cryptocurrency wallet to the smart contract to associate the user with the smart contract and Web3 application. The facility generates one or more cryptocurrency transaction to facilitate the user's interaction with the Web3 application.

### CROSS-REFERENCE TO RELATED APPLICATION(S)

This application is a continuation in part of, and claims the benefit and priority to, U.S. application Ser. No. 17/949,559, filed Sep. 21, 2022, the entirety of which is hereby incorporated by reference. Where the present application and a document incorporated by reference conflict, the present application controls.

### BACKGROUND

The advent of blockchain and Web3 has led to a decentralization and individualization of internet services. Users of Web3 and blockchain applications and networks use cryptocurrency contained by a “wallet” to interact with such applications. Furthermore, interactions with such applications utilize “transactions” of cryptocurrency from one wallet to another; networking and computer systems facilitate transactions.

### BRIEF DESCRIPTION OF THE SEVERAL VIEWS OF THE DRAWINGS

FIG. 1 is a block diagram showing some of the components typically incorporated in at least some of the computer systems and other devices on which the facility operates.

FIG. 2 is a table diagram of a wallet creation data table used by the facility in some embodiments.

FIG. 3 is a flow diagram of a process to generate a cryptocurrency wallet used by the facility in some embodiments.

FIG. 4 is a flow diagram of a process to apply a cryptocurrency wallet to a smart contract associated with a Web3 application used by the facility in some embodiments.

FIG. 5 is a flow diagram of a process to alter a smart contract to support meta-transactions used by the facility in some embodiments.

FIG. 6 is a flow diagram of a process to generate cryptocurrency transactions for a user used by the facility in some embodiments.

FIG. 7 is a flow diagram of a process to generate cryptocurrency transactions based on user interaction with a Web3 application used by the facility in some embodiments.

FIG. 8 is a table diagram of a cryptocurrency pool data table used by the facility in some embodiments.

FIG. 9 is a flow diagram of a process to claim cryptocurrency rewards included in a cryptocurrency pool used by the facility in some embodiments.

### DETAILED DESCRIPTION

The inventors have recognized a variety of disadvantages of current methods to the creation and management of cryptocurrency wallets for interaction with Web3 and blockchain applications (collectively “Web3 applications”). First, creating cryptocurrency wallets requires technical proficiency in their creation and use. This means users must spend time, effort, and computing resources to create, fund, and manage the wallets. Furthermore, each blockchain is built upon “native tokens,” upon which other cryptocurrency can be created or through which Web3 applications can operate. In conventional systems, users must obtain and use native tokens in order to interact with Web3 applications, or must convert existing tokens in their wallet into native tokens in order to use them to interact with Web3 applications. Conversion of native tokens, as well as regular interactions with Web3 applications, typically require the payment of “gas fees” in order to facilitate the transactions and interactions. In such conventional systems, the cost to submit and receive cryptocurrency related to interaction with Web3 applications can be prohibitively high for users due to “gas fees” paid to facilitate the transactions required to obtain native tokens or interact with Web3 applications. Conventionally, gas fees are charged per transaction, and represent a fee for the using computer processing power and memory resources to update a blockchain hosting the cryptocurrency to include the transaction.

Furthermore, users must manually keep track of their wallet and native tokens in order to interact with Web3 applications. This results in the use of many “fail-safe” systems to accurately track wallet access details and token usage.

In response to recognizing these disadvantages, the inventors have conceived and reduced to practice a software and/or hardware facility for managing and creating cryptocurrency wallets for interaction with Web3 applications.

The facility creates one or more non-custodial cryptocurrency wallets for users and manages such wallets to facilitate users' interaction with Web3 applications. The facility receives an indication from a user that they wish to create a cryptocurrency wallet and creates one or more non-custodial wallets for the user. In some embodiments, the indication that a user wishes to create a cryptocurrency wallet includes an email address of the user.

The facility locks a cryptocurrency wallet upon creation by causing a key required for access to the wallet to be generated and provided to the user. In some embodiments, the facility utilizes a key management service as part of creating the cryptocurrency wallet in order to ensure that the cryptocurrency wallet is a non-custodial wallet. In some embodiments, the facility causes the wallet to be unusable until the user has accessed the wallet. In some embodiments, the facility does not itself store an indication of the key, and is unable to otherwise access the key.

The facility facilitates transactions used for interaction with Web3 applications to which the wallet is connected via a smart contract. The facility receives an indication that a user wishes to interact with a particular Web3 application and determines which transactions and tokens are necessary for interacting the application to be performed. The facility causes at least a portion of the transactions necessary for interaction with the application to be performed. In some embodiments, the facility causes native tokens that are necessary for interaction with the application to be included in the necessary transactions even when the user's cryptocurrency wallet does not include the native tokens. For example, the facility may alter the transactions to include native tokens from a source of native tokens, such as another cryptocurrency wallet, thus altering the transactions to be “meta-transactions.” In some embodiments, the facility causes a smart contract associated with the Web3 application to be configured to support meta-transactions as part of connecting the wallet to the Web3 application via the smart contract.

The facility uses “meta-transactions” to facilitate the transactions performed for user interaction with Web3 applications. A meta-transaction is a transaction that is subsidized by an entity indicated by a smart contract such that the participants of the transaction are not required to pay fees to execute the transaction. The facility generates the meta-transaction based on the Web3 application to which the user intends to interact. In some embodiments, the facility uses the meta-transaction to ensure that a user is able to interact with the Web3 application without being required to own a certain number of native tokens for the blockchain upon which the Web3 application operates. For example, for a user who owns a first type of token but wishes to use a Web3 application that operates on a blockchain with a native token that is not the first type of token, the facility generates a meta-transaction to allow the user to interact with the Web3 application even though the user does not any of the native token. In some embodiments, the facility uses a layer two blockchain network to create cryptocurrency transactions. In some embodiments, the facility generates and facilitates transactions between multiple blockchain networks, such as Polygon, Binance, or other blockchain networks.

The facility generates a cryptocurrency pool for users to claim cryptocurrency received as a result of their interaction with Web3 applications. The facility continues to fill the cryptocurrency pool as cryptocurrency is awarded to a user and allows the user to claim all of the cryptocurrency at once in a single transaction. In some embodiments, the facility receives an indication from the user that a different wallet should be used to claim the cryptocurrency in the pool, and the facility causes the cryptocurrency in the pool to be transferred to the different wallet. In some embodiments, the facility creates the cryptocurrency pool based on a smart contract that connects the Web3 application to the wallet.

By performing in some or all of the ways described above, the facility automates the creation and management of cryptocurrency wallets and transactions for users' interaction with Web3 applications. For example, by using meta-transactions, such as those used on the Ethereum blockchain, the facility is able to significantly reduce gas fees and the time and computing resources necessary to obtain native tokens used for interacting with Web3 applications. The facility additionally allows a user with little to no technical proficiency to automatically create a cryptocurrency wallet and connect the cryptocurrency wallet to smart contracts and Web3 applications. Furthermore, the facility configures smart contracts to support meta-transactions if they are not already configured to support such transactions.

Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by using meta-transactions and automating the process for obtaining native tokens necessary to interact with Web3 applications, the facility significantly reduces the computing power and resources necessary to interact with Web3 applications, such as by providing the correct tokens for interaction with the Web3 application. Such computing resources include the processing, memory, and other computing resources which would ordinarily be required for the additional transactions needed to obtain native tokens, either by purchasing the tokens or by converting other cryptocurrency into the native tokens. Additionally, by using cryptocurrency pools, the facility is able to reduce the total number of cryptocurrency transactions needed to distribute cryptocurrency to users, thus reducing the processing power and fees required to generate and execute the cryptocurrency transactions.

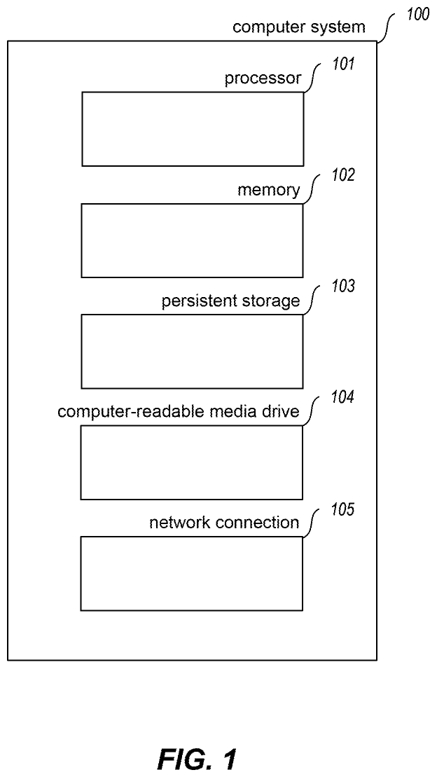

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, Neural Network Accelerator, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

Those skilled in the art will appreciate that the acts shown in the flow diagrams discussed below may be altered in a variety of ways. For example, the order of the acts may be rearranged; some acts may be performed in parallel; shown acts may be omitted, or other acts may be included; a shown act may be divided into subtracts, or multiple shown acts may be combined into a single act, etc.

Furthermore, while the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed, encrypted, and/or indexed; may contain a much larger number of rows than shown, etc.

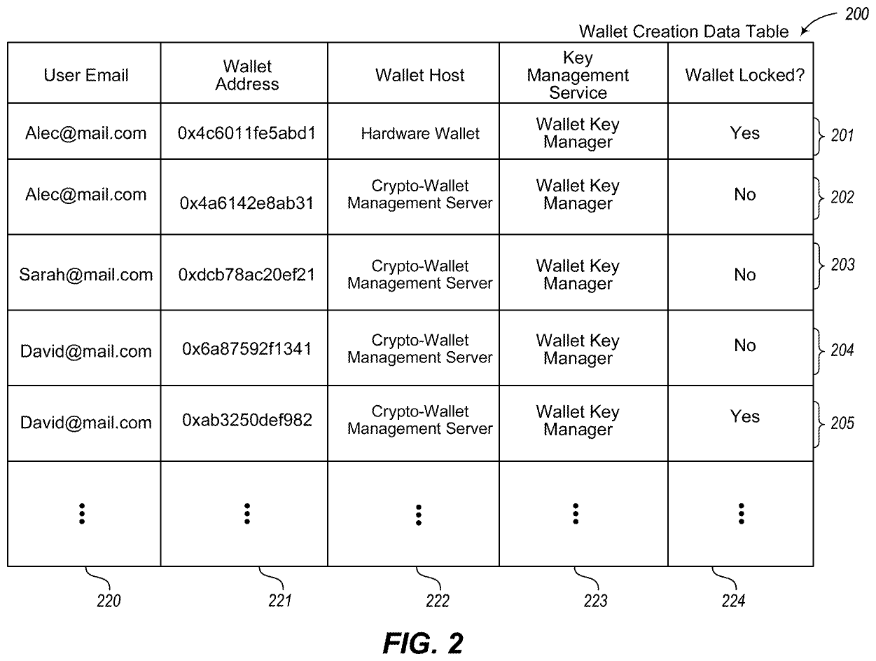

FIG. 2 is a table diagram of a wallet creation data table 200 used by the facility in some embodiments. The wallet creation data table 200 includes data related to cryptocurrency wallets generated by the facility. The rows of the wallet creation data table each correspond to a different cryptocurrency wallet and include data about the cryptocurrency wallet used by the facility. The wallet creation data table 200 includes a user email column 220, a wallet address column 221, a wallet host column 222, a key management service column 223, and a wallet locked column 224.

The user email column 220 includes data indicating an email address or other identifying information for a user that controls a cryptocurrency wallet. The wallet address column 221 includes information specifying a cryptocurrency wallet associated with a user indicated in the user email column 220. The wallet host column 222 includes data indicating an entity that hosts the cryptocurrency wallet. The key management service column 223 includes data indicating a key management service associated with the cryptocurrency wallet. The wallet locked column 224 includes data indicating whether the cryptocurrency wallet is currently locked.

For example, row 201 indicates that the user having the email address “Alec@mail.com” has a hardware wallet that uses the wallet key manager and is currently locked. As a result of being locked, the facility can't use the wallet indicated in row 201 to generate transactions or to apply the wallet to a smart contract associated with a Web3 application. In contrast, row 203 indicates that the user having the email address “Sarah@mail.com” has an unlocked wallet hosted on the “Crypto-Wallet Management Server.” As a result, the facility would be able to use the wallet indicated in row 203 to generate transactions and apply the wallet to a smart contract associated with a Web3 application.

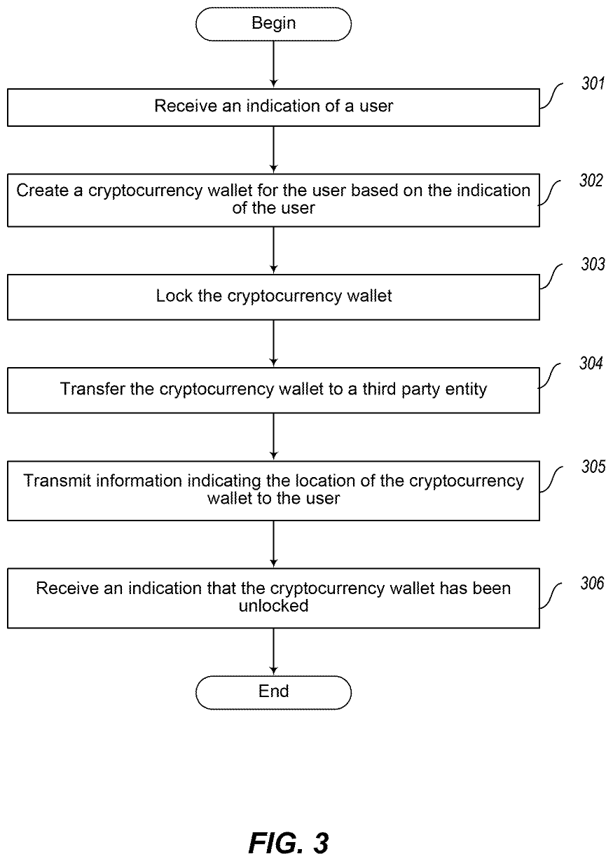

FIG. 3 is a flow diagram of a process to generate a cryptocurrency wallet used by the facility in some embodiments. First, at act 301, the facility receives an indication of a user. In some embodiments, the indication of the user includes an email address or other information identifying the user.

At act 302, the facility creates a cryptocurrency wallet based on the indication of the user. In some embodiments, the facility creates the cryptocurrency wallet by causing the indication of the user to be transmitted to a third party wallet management tool.

At act 303, the facility locks the cryptocurrency wallet and causes a password to unlock the cryptocurrency wallet to be generated. While the cryptocurrency wallet is locked, the cryptocurrency wallet is unable to be used to send cryptocurrency or to be used with Web3 applications.

At act 304, the facility causes the cryptocurrency wallet to be transferred to a third party entity. In some embodiments, the third party entity is a cryptocurrency wallet hosting service that is not associated with the user or with the facility.

At act 305, the facility transmits information indicating the location of the cryptocurrency wallet to the user. In some embodiments, at act 305, the facility transmits a password to unlock the cryptocurrency wallet to a device associated with the user.

At act 306, the facility receives an indication that the cryptocurrency wallet has been unlocked. In some embodiments, the facility receives the indication that the cryptocurrency wallet has been unlocked from a third party entity that hosts the cryptocurrency wallet. In some embodiments, to determine whether the cryptocurrency wallet has been unlocked, the facility generates a transaction for the user and requests that the user sign the transaction.

After act 306, the process to generate a cryptocurrency wallet ends.

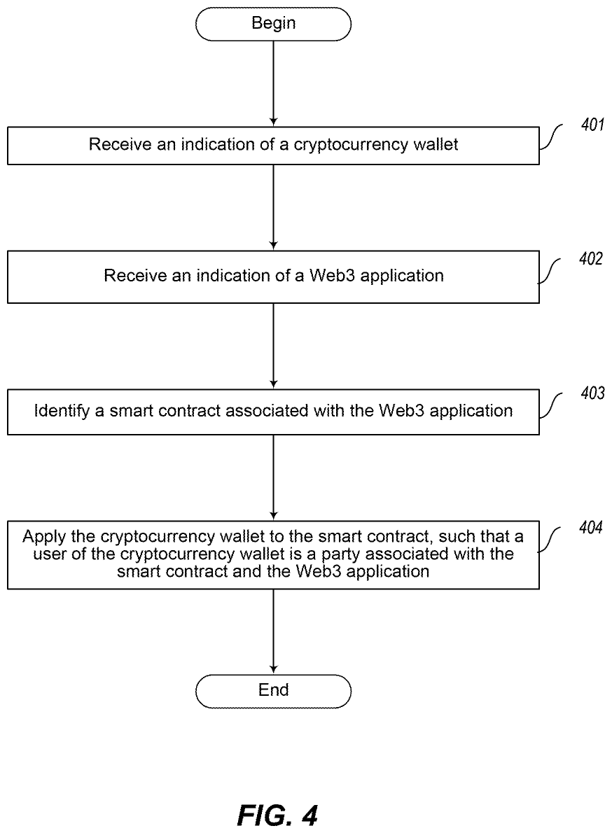

FIG. 4 is a flow diagram of a process to apply a cryptocurrency wallet to a smart contract associated with a Web3 application used by the facility in some embodiments. First, at act 401, the facility receives an indication of a cryptocurrency wallet associated with a user. At act 402, the facility receives an indication of a Web3 application, such as via user input.

At act 403, the facility identifies a smart contract associated with the Web3 application. In some embodiments, the facility identifies the smart contract by receiving an indication of the smart contract from the Web3 application, such as in response to a request by the facility for the smart contract.

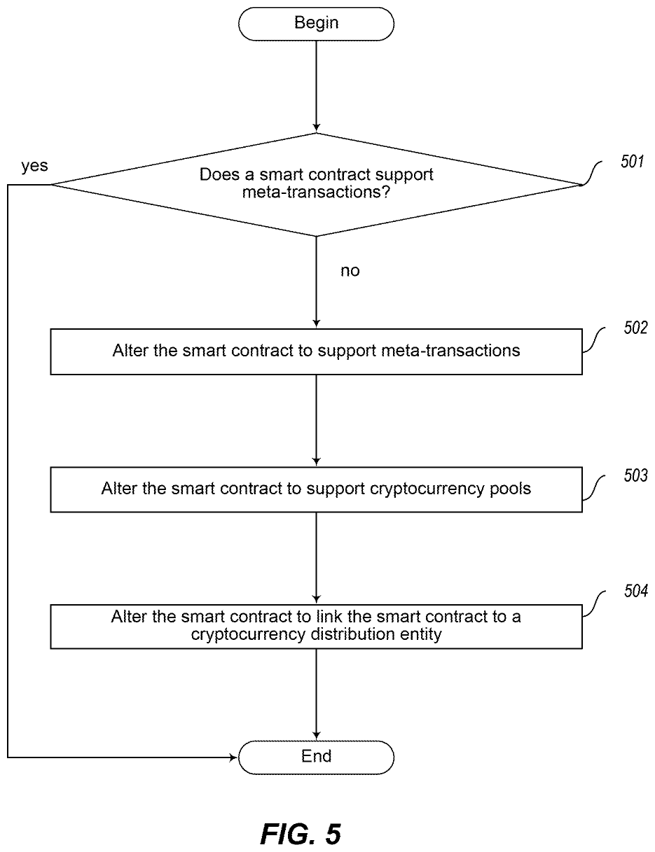

At act 404, the facility applies the cryptocurrency wallet to the smart contract, such that a user of the cryptocurrency wallet is a party associated with the smart contract and the Web3 application. In some embodiments, as part of performing act 404, the facility performs the process to alter a smart contract to support meta-transactions, described below in connection with FIG. 5.

After act 404, the process to apply a cryptocurrency wallet to a smart contract associated with a Web3 application ends.

FIG. 5 is a flow diagram of a process to alter a smart contract to support meta-transactions used by the facility in some embodiments. First, at act 501, the facility determines whether the smart contract supports meta-transactions. If the facility determines that the smart contract already supports meta-transactions, the process to alter a smart contract to support meta-transactions ends, otherwise the process proceeds to act 502.

At act 502, the facility alters the smart contract to support meta-transactions. In some embodiments, at act 502, the facility alters the smart contract by linking the smart contract to a gas station network, such as OpenGSN. A gas station network is a network of relayers that are used to sign and send cryptocurrency transactions. A relayer receives, signs, and submits transactions to the blockchain along with the gas fees required to execute the transaction. In some embodiments, at act 502, the facility links a “paymaster” contract to the smart contract and the gas station network. A paymaster contract is a smart contract that holds funds used to pay gas fees on a blockchain. In such embodiments, the smart contract is altered such that a relayer associated with the gas station network deducts gas fees from the paymaster contract instead of from a user's cryptocurrency wallet.

At act 503, the facility alters the smart contract to support cryptocurrency pools. In some embodiments, altering the smart contract to support cryptocurrency pools includes altering the smart contract to store indications of cryptocurrency awards received by users of the Web3 application and to refrain from initiating transactions to distribute the cryptocurrency awards until receiving an indication from a user that the user wishes to claim the cryptocurrency awards. In such embodiments, the facility is able to reduce the number of transactions performed on behalf of the Web3 application by ensuring that multiple distinct cryptocurrency awards can be included in a single transaction instead of performing a transaction for each award received by a user.

At act 504, the facility alters the smart contract to link the smart contract to a cryptocurrency distribution entity. In some embodiments, the cryptocurrency distribution entity is a “paymaster” that is able to alter and validate cryptocurrency transactions generated based on the smart contract. In some embodiments, the cryptocurrency distribution entity has access to a plurality of native tokens that can be used for gas fees. In such embodiments, the cryptocurrency distribution entity alters transactions associated with the user's interaction with the Web3 application to include native tokens necessary to pay the gas fees by using the plurality of native tokens.

After act 504, the process to alter a smart contract to support meta-transactions ends.

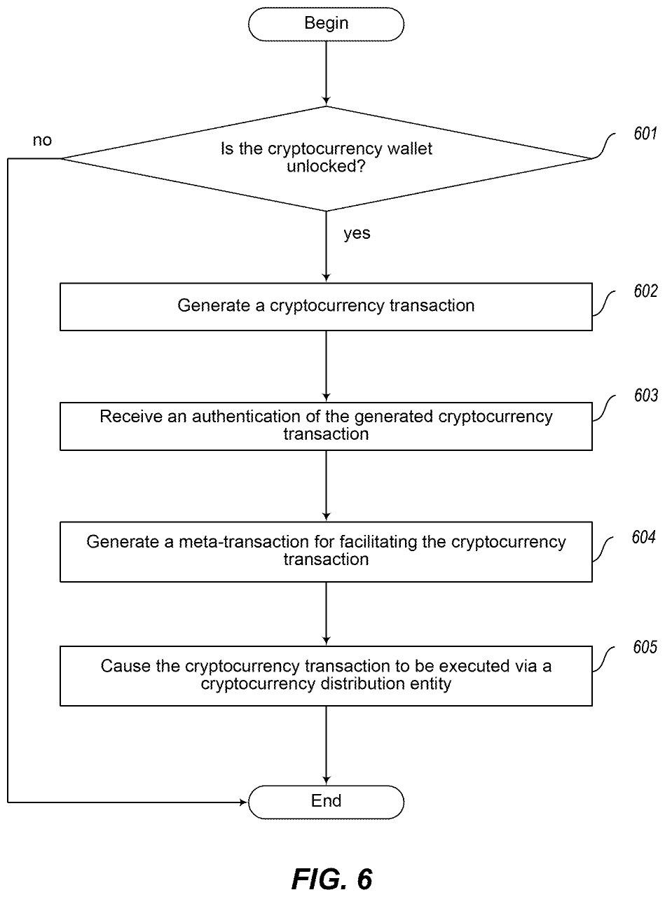

FIG. 6 is a flow diagram of a process to generate cryptocurrency transactions for a user used by the facility in some embodiments. First, at act 601, the facility determines whether the cryptocurrency wallet is unlocked. If the cryptocurrency wallet is not unlocked, the process ends, otherwise, the process proceeds to act 602.

At act 602, the facility generates a cryptocurrency transaction based on the cryptocurrency wallet and the smart contract. In some embodiments, the facility generates the cryptocurrency transaction in response to a detected interaction by a user with a Web3 application. In some embodiments, the facility generates the cryptocurrency transaction in response to a request by a user to claim one or more cryptocurrency awards. The generated cryptocurrency transaction includes one or more of: at least one destination address of a cryptocurrency wallet, at least one address of a cryptocurrency wallet from which the cryptocurrency currently resides, and an indication of the cryptocurrency tokens subject to the transaction.

At act 603, the facility receives an authentication of the generated cryptocurrency transaction, such as via user input. In some embodiments, the authentication of the generated cryptocurrency transaction includes: a signature, a password, or any other indication that the generated cryptocurrency transaction is authentic.

At act 604, the facility generates a meta-transaction for facilitating the cryptocurrency transaction based on the smart contract and the cryptocurrency transaction. In some embodiments, when generating the meta-transaction, the facility determines which native tokens are required to execute the transaction.

At act 605, the facility causes the cryptocurrency transaction to be executed via a cryptocurrency distribution entity, such as a paymaster. Causing the cryptocurrency transaction to be executed includes using the meta-transaction to provide the native tokens necessary to execute the cryptocurrency transaction. In some embodiments, at act 605, the facility alters the cryptocurrency transaction to include the meta-transaction before causing the cryptocurrency transaction not be executed.

After act 605, the process to generate cryptocurrency transactions for a user ends.

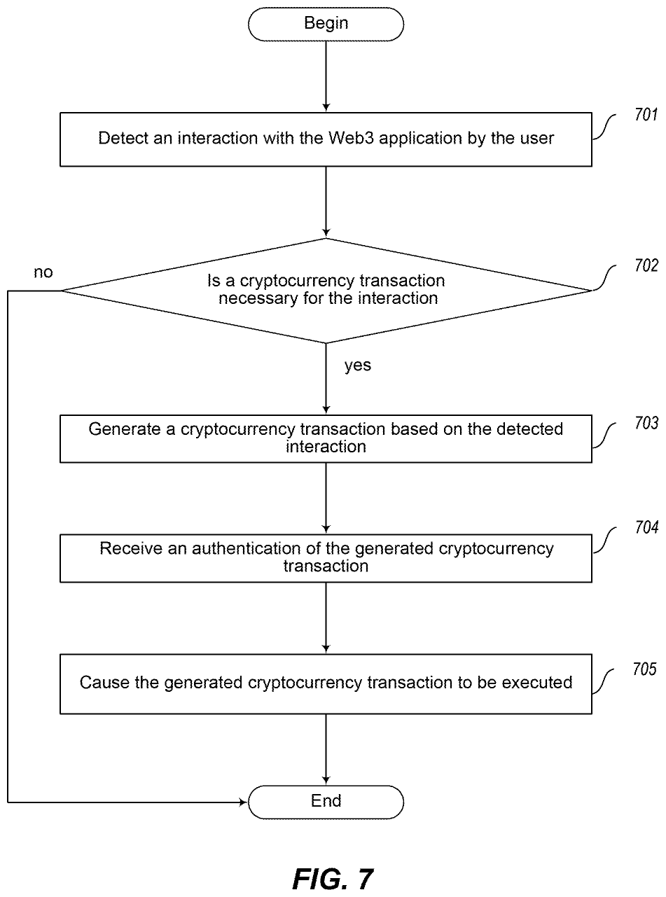

FIG. 7 is a flow diagram of a process to generate cryptocurrency transactions based on user interaction with a Web3 application used by the facility in some embodiments. First, at act 701, the facility detects an interaction with the Web3 application by the user. In some embodiments, the facility receives an indication of the interaction from one or more of: the Web3 application, the smart contract, a request for a cryptocurrency transaction, the user, and other sources of data indicating an interaction with a Web3 application.

At act 702, the facility determines whether a cryptocurrency transaction is necessary for the interaction. In some embodiments, the facility determines whether a cryptocurrency transaction is necessary for the interaction based on one or more of: the indication of the interaction, the smart contract, data associated with the Web3 application, user input, and other data usable to determine whether a cryptocurrency transaction is necessary for interaction with a Web3 application. If the facility determines that a cryptocurrency transaction is not necessary for the interaction, the process ends, otherwise, the process proceeds to act 703.

At act 703, the facility generates a cryptocurrency transaction based on the detected interaction with the Web3 application. The cryptocurrency transaction may be generated in a similar manner to act 602, described above in connection with FIG. 6.

At act 704, the facility receives an authentication of the generated cryptocurrency transaction. The facility may perform act 704 in a similar manner to act 603, described above in connection with FIG. 6.

At act 705, the facility causes the generated cryptocurrency transaction to be executed. The facility may perform act 705 in a similar manner to act 605. In some embodiments, the cryptocurrency transaction is caused to include a meta-transaction before the cryptocurrency transaction is caused to be executed.

After act 705, the process to generate cryptocurrency transactions based on user interaction with a Web3 application ends.

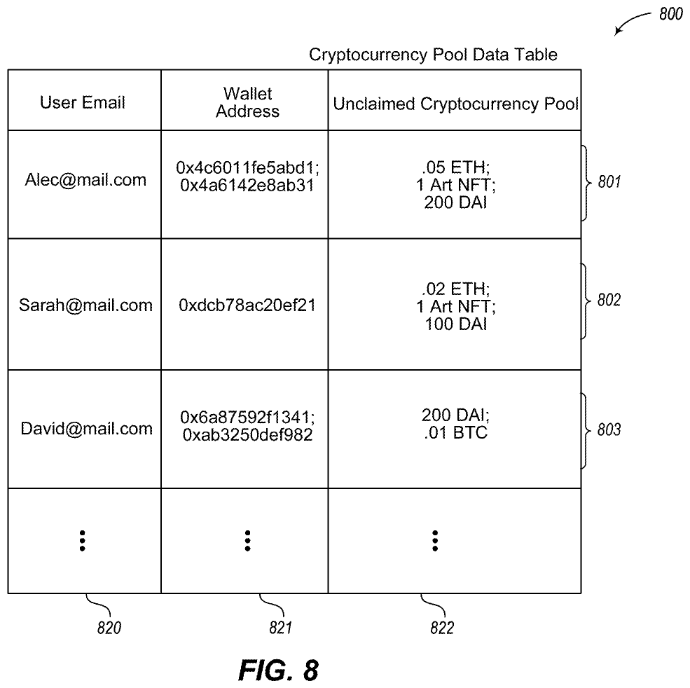

FIG. 8 is a table diagram of a cryptocurrency pool data table 800 used by the facility in some embodiments. The cryptocurrency pool data table 800 includes data related to the cryptocurrency awards received by users of the Web3 application that the users have not yet claimed. In some embodiments, the facility alters a smart contract associated with a Web3 application to include a cryptocurrency pool data table, such as the cryptocurrency pool data table 800, and to record cryptocurrency awards associated with user interaction with the Web3 application in the cryptocurrency pool data table. In such embodiments, the smart contract may be further altered to prevent the transmission of cryptocurrency awards indicated in the cryptocurrency pool until a user has indicated that they wish to claim one or more cryptocurrency tokens associated with their interaction with the Web3 application. The rows of the cryptocurrency pool data table 800 each correspond to a different user and include data about the cryptocurrency wallets and unclaimed cryptocurrency rewards associated with the user. The cryptocurrency pool data table 800 includes a user email column 820, a wallet address column 821, and an unclaimed cryptocurrency pool column 822.

The user email column 820 is similar to the user email column 220 described above in connection with FIG. 2. The wallet address column 821 includes information specifying one or more cryptocurrency wallet addresses for cryptocurrency wallets associated with the user indicated in the user email column 820. The unclaimed cryptocurrency pool column 822 includes information specifying one or more cryptocurrency awards earned by the user as a result of the user's interaction with a Web3 application.

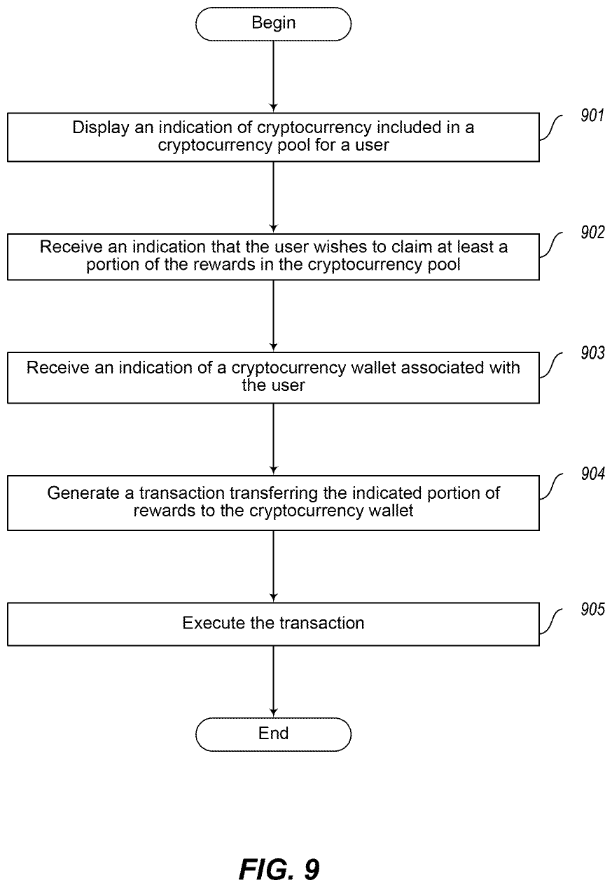

For example, row 801 indicates that a user having the email address “Alec@mail.com” is associated with two cryptocurrency wallets and has multiple cryptocurrency tokens in the unclaimed cryptocurrency pool. In this example, this user can claim some or all of the cryptocurrency tokens in the unclaimed cryptocurrency pool and can specify either or both of his associated cryptocurrency wallets as the destination of the cryptocurrency tokens. In some embodiments, to allow a user to claim one or more cryptocurrency tokens in the unclaimed cryptocurrency pool, the facility performs the performs the process described below in connection with FIG. 9.

FIG. 9 is a flow diagram of a process to claim cryptocurrency rewards included in a cryptocurrency pool used by the facility in some embodiments. First, at act 901, the facility displays an indication of cryptocurrency included in a cryptocurrency pool to a user. In some embodiments, the facility uses data included in a cryptocurrency pool data table to display the indication of the cryptocurrency, such as the cryptocurrency pool data table 800 described above in connection with FIG. 8.

At act 902, the facility receives an indication that the user wishes to claim at least a portion of the rewards in the cryptocurrency pool, such as via user input.

At act 903, the facility receives an indication of a cryptocurrency wallet associated with a user, such as via user input. In some embodiments, the facility receives an indication of multiple crypto currency wallets associated with the user. In such embodiments, the facility may receive an indication of which cryptocurrency rewards are to be transferred to each of the indicated wallets.

At act 904, the facility generates a transaction to transfer the indicated portion of the cryptocurrency rewards to the indicated cryptocurrency wallet. In embodiments where the facility receives an indication of multiple cryptocurrency wallets at act 903, the transaction is generated based on the multiple cryptocurrency wallets and any indications of whether certain cryptocurrency rewards should be transferred to certain cryptocurrency wallets.

At act 905, the facility executes the generated transaction. In some embodiments, the facility executes the generated transaction in a similar manner to act 605. In some embodiments, the generated transaction is caused to include a meta-transaction before the it is caused to be executed.

After act 905, the process to claim cryptocurrency rewards included in a cryptocurrency pool ends.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. One or more instances of computer-readable media collectively having contents configured to cause a computing device to perform a method for creating cryptocurrency wallets for Web3 applications, the method comprising:
receiving an indication of a user;
generating a cryptocurrency wallet based on the indication of the user;
receiving an indication of a Web3 application;
identifying a smart contract associated with the Web3 application;
automatically applying the cryptocurrency wallet to the smart contract, such that the user is a party associated with the smart contract and the Web3 application; and
automatically generating one or more cryptocurrency transactions based on the smart contract and the cryptocurrency wallet to facilitate the user's interaction with the Web3 application.

2. The one or more instances of computer-readable media of claim 1, wherein automatically generating one or more cryptocurrency transactions further comprises:
detecting an interaction with the Web3 application by the user;
determining that a cryptocurrency transaction is necessary for the user's interaction with the Web3 application;
generating the cryptocurrency transaction based on the contents of the cryptocurrency wallet, the Web3 application, and the detected interaction,
the method further comprising:
causing the generated cryptocurrency transaction to be executed.

3. The one or more instances of computer-readable media of claim 2 wherein the generated cryptocurrency transaction is a meta-transaction.

4. The one or more instances of computer-readable media of claim 1, wherein automatically generating one or more cryptocurrency transactions further comprises:
receiving an authentication of at least one generated cryptocurrency transaction from the user.

5. The one or more instances of computer-readable media of claim 1, wherein the method further comprises:
altering the smart contract to support the creation of meta-transactions.

6. The one or more instances of computer-readable media of claim 1, wherein automatically generating one or more cryptocurrency transactions further comprises:
detecting an interaction with the Web3 application by the user;
determining whether one or more native tokens should be obtained based on the detected interaction, the smart contract, and the cryptocurrency wallet; and
based on the determining:
generating one or more cryptocurrency transactions to obtain at least a portion of the native tokens; and
causing the one or more cryptocurrency transactions to be executed.

7. The one or more instances of computer-readable media of claim 1, wherein generating a cryptocurrency wallet further comprises:
causing the cryptocurrency wallet to be locked, such that the cryptocurrency wallet cannot be used while it is locked;
causing a code for unlocking the cryptocurrency wallet to be generated; and
causing the code to be provided to the user based on the information indicating the user.

8. The one or more instances of computer-readable media of claim 1, wherein automatically generating one or more cryptocurrency transactions further comprises:
identifying one or more cryptocurrency rewards earned by the user as a result of the user's interaction with the Web3 application;
causing at least a portion of the one or more cryptocurrency rewards to be stored in a cryptocurrency pool;
receiving an indication that a portion of the cryptocurrency rewards stored in the cryptocurrency pool should be transmitted to a user, the received indication including an indication of a destination cryptocurrency wallet; and
causing the portion of the cryptocurrency rewards to be transferred to the destination cryptocurrency wallet.

9. A system for creating cryptocurrency wallets for Web3 applications, the system comprising:
a computing device configured to:
receive an indication of a user;
generate a cryptocurrency wallet based on the indication of the user;
receive an indication of a Web3 application;
identify a smart contract associated with the Web3 application;
automatically apply the cryptocurrency wallet to the smart contract, such that the user is a party associated with the smart contract and the Web3 application; and
automatically generate one or more cryptocurrency transactions based on the smart contract and the cryptocurrency wallet to facilitate the user's interaction with the Web3 application.

10. The system of claim 9, wherein to generate one or more cryptocurrency transactions, the computing device is further configured to:
detect an interaction with the Web3 application by the user;
determine that a cryptocurrency transaction is necessary for the user's interaction with the Web3 application;
generate the cryptocurrency transaction based on the contents of the cryptocurrency wallet, the Web3 application, and the detected interaction,
the computing device being further configured to:
receive an authentication of the generated cryptocurrency transaction from the user; and
cause the generated cryptocurrency transaction to be executed.

11. The system of claim 9, wherein the computing device is further configured to:
alter the smart contract to support the creation of meta-transactions.

12. The system of claim 9, wherein to generate one or more cryptocurrency transactions, the computing device is further configured to:
detect an interaction with the Web3 application by the user;
determine whether one or more native tokens should be obtained based on the detected interaction, the smart contract, and the cryptocurrency wallet; and
based on the determining:
generate one or more cryptocurrency transactions to obtain at least a portion of the native tokens; and
cause the one or more cryptocurrency transactions to be executed.

13. The system of claim 9, wherein to generate the cryptocurrency wallet, the computing device is further configured to:
cause the cryptocurrency wallet to be locked, such that the cryptocurrency wallet cannot be used while it is locked;
cause a code for unlocking the cryptocurrency wallet to be generated; and
cause the code to be provided to the user based on the information indicating the user.

14. The system of claim 9, wherein to generate one or more cryptocurrency transactions, the computing device is further configured to:
identify one or more cryptocurrency awards earned by the user as a result of the user's interaction with the Web3 application;
cause at least a portion of the one or more cryptocurrency awards to be stored in a cryptocurrency pool;
receive an indication that a portion of the cryptocurrency awards stored in the cryptocurrency pool should be transmitted to a user, the received indication including an indication of a destination cryptocurrency wallet; and
cause the portion of the cryptocurrency awards to be transferred to the destination cryptocurrency wallet.

15. A method comprising:
receiving an indication of a user;
generating a cryptocurrency wallet based on the indication of the user;
receiving an indication of a Web3 application;
identifying a smart contract associated with the Web3 application;
automatically applying the cryptocurrency wallet to the smart contract, such that the user is a party associated with the smart contract and the Web3 application; and
automatically generating one or more cryptocurrency transactions based on the smart contract and cryptocurrency wallet to facilitate the user's interaction with the Web3 application.

16. The method of claim 15, wherein generating one or more cryptocurrency transactions further comprises:
detecting an interaction with the Web3 application by the user;
determining that a cryptocurrency transaction is necessary for the user's interaction with the Web3 application;
generating the cryptocurrency transaction based on the contents of the cryptocurrency wallet, the Web3 application, and the detected interaction;
receiving an authentication of the generated cryptocurrency transaction from the user, the method further comprising:
causing the generated cryptocurrency transaction to be executed.

17. The method of claim 15, wherein the method further comprises:
altering the smart contract to support the creation of meta-transactions.

18. The method of claim 15, wherein generating one or more cryptocurrency transactions further comprises:
detecting an interaction with the Web3 application by the user;
determining whether one or more native tokens should be obtained based on the detected interaction, the smart contract, and the cryptocurrency wallet; and
based on the determining:
generating one or more cryptocurrency transactions to obtain at least a portion of the native tokens; and
causing the one or more cryptocurrency transactions to be executed.

19. The method of claim 15, wherein generating a cryptocurrency wallet further comprises:
causing the cryptocurrency wallet to be locked, such that the cryptocurrency wallet cannot be used while it is locked;
causing a code for unlocking the cryptocurrency wallet to be generated; and
causing the code to be provided to the user based on the information indicating the user.

20. The method of claim 15, wherein generating one or more cryptocurrency transactions further comprises:
identifying one or more cryptocurrency tokens earned by the user as a result of the user's interaction with the Web3 application;
causing at least a portion of the one or more cryptocurrency tokens to be stored in a cryptocurrency pool;
receiving an indication that a portion of the cryptocurrency tokens stored in the cryptocurrency pool should be transmitted to a user, the received indication including an indication of a destination cryptocurrency wallet; and
causing the portion of the cryptocurrency tokens to be transferred to the destination cryptocurrency wallet.
